(19) United States
(12) Patent Application Publication
(10) Pub. No.: US 2020/0090133 A1
(43) Pub. Date: Mar. 19, 2020

(54) SYSTEM FOR SCHEDULING AND MONITORING SERVICE CALL

(71) Applicant: Avi Kessler, Valley Village, CA (US)

(72) Inventor: Avi Kessler, Valley Village, CA (US)

(21) Appl. No.: 16/135,984

(22) Filed: Sep. 19, 2018

(51) Int. Cl. G06Q 10/10; H04W 4/029; H04W 4/02; H04L 29/08

(52) U.S. Cl. CPC G06Q 10/1095; H04L 67/327; H04W 4/025; H04W 4/029

(57) ABSTRACT

A system for remotely scheduling and monitoring arrival time of a service at a site by a requester of the service is shown and described. The requester may initiate a request for service e.g. by a smartphone, and be apprised of contemplated arrival time or time ranges via the smartphone. Progress of the service personnel is periodically annunciated in stages or increments of progress. The system makes the same data available to service providers and system administrators, who may then more efficiently manage individual service providers.

### FIELD OF THE INVENTION

The present invention relates to a system for scheduling service calls and monitoring progress of an impending service that can be used by various city departments to make them more efficient and organized as it relates to the public in need of their services.

### BACKGROUND OF THE INVENTION

Services such as municipal building inspections may be required periodically throughout a procedure such as construction of a building. In some cases, further progress may not be attempted until certain items have passed inspection. Inspectors typically have busy work days, and it is somewhat unpredictable as to when the inspector will arrive. Especially in large municipalities, there are a great many inspectors. These inspectors may be dispatched for example by a list of inspections drawn up in the morning, prior to the inspector leaving the office to conduct the inspections. This sets up an inefficient use of inspector time, in that in the course of a day, an inspector may not be assigned as efficiently a possible. Consequent inefficient routing may result in waits and in increased transit times from site to site.

In most cases, a person of authority in the construction of a building must be present to receive and guide the inspector. This potentially poses a great demand on the person of authority as to time, in that this person may have to wait throughout much of a day for the inspector, with little constructive use of his or her time during such a wait. Also, other construction building personnel may have to cease their work until cleared for resuming work. Obviously, this situation threatens to exact economic costs to builders, contractors, commercial property managers, property owners, etc.

It is known to schedule an inspection for a predetermined time window. However, these time windows may be fairly broad, so that there is still an opportunity for unproductive waiting by the person of authority and idling of construction personnel. There exists a need for an improved way of scheduling a service such as for municipal construction inspectors so that arrival times are more predictable and accurate.

### SUMMARY OF THE INVENTION

The disclosed concepts address the above stated situation by providing an efficient system for remotely scheduling and monitoring arrival time of a service by various departments from their standpoint and how they relate to the public who need their services. The requester may initiate a request for service e.g. by a smartphone, and be apprised of contemplated arrival time or time ranges via the smartphone. Progress of the service personnel is periodically annunciated in stages or increments of progress. Succeeding annunciations may announce shorter time ranges, where arrival is within a specified time range. A final annunciation announces that the service provider is actually en route. A link to a graphic display of service provider location may be provided.

One contemplated application of the system is in managing municipal building inspectors assigned to construction projects. The system identifies the most optimal inspector of many candidate inspectors, and assigns the identified inspector to inspection requests. The system enables property owners, managers, contractors, and construction personnel to know increasingly accurate contemplated arrival times or time ranges of inspectors, thereby enabling the former to make productive use of time, and also enables municipal authorities to assign inspectors efficiently and to track individual inspector performance.

The novel system may be implemented as a computerized system utilizing applications downloaded to smartphones or the like in possession of the service providers. Computer terminals at a central station may implement the system and make results available to the operators of the system, whether in one central location or in plural locations.

The system offers significant savings to municipalities. Firstly, service providers such as building inspectors can be more efficiently dispatched. This can be done by assigning inspectors based on geographic proximity to inspection sites, rather than by the usual system of first requester to call in. Beyond that, the system can calculate the best route from the inspector's location to the next inspection site, thereby saving additional time. Also, various forms of data pertaining to inspection sites can be entered by inspectors into the system, which reduces complexity, time, and costs of future administrative requirements. Data can pertain to construction details, such as the number of water consuming appliances or outlets, or may pertain to permits, insurance issues, dates required for future actions such as reinspections, and still other situations. Therefore, future record keeping costs imposed on the municipality can be minimized.

One object of the invention is to provide a platform for coordinating dispatch of service providers, such as municipal building inspectors, with contractors, construction managers, property owners, etc. Another object of the invention is to provide a platform for managing a plurality of service providers, such as inspectors, by a central management authority, such as a municipality charged with monitoring construction projects. Management will encompass optimally efficient scheduling and assigning of the inspectors. A further object is providing an automated interface for requesting services such as inspections, reporting anticipated arrival times of the service providers to the service requesters on a periodically updated basis, and real time tracking of the service provider's progress in transit.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic representation of parties of a system for remotely scheduling and monitoring arrival time of a service at a site by a requester of the service, according to at least one aspect of the invention;

FIGS. 2-6 each show exemplary screen content which may be generated on e.g. a screen of a smartphone used by the requester of the service alluded to with respect to FIG. 1; and

FIGS. 7-10 each show exemplary screen content which may be generated on e.g. a screen of a smartphone or the like used by individual providers of the service alluded to with respect to FIG. 1.

### DETAILED DESCRIPTION

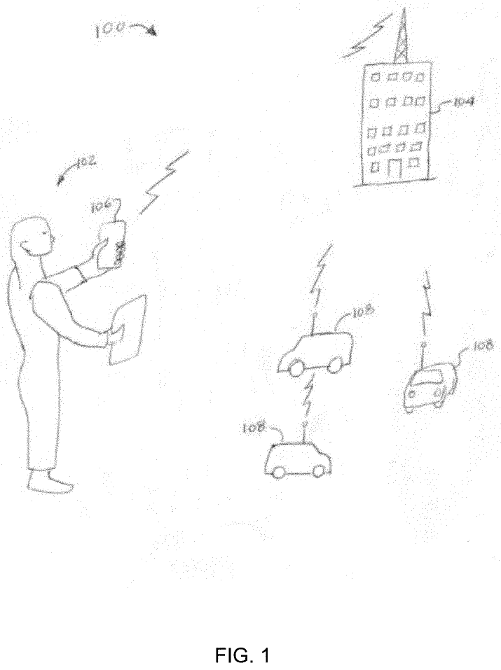

Referring first to FIG. 1, according to at least one aspect of the invention, there is shown a representative system 100 for remotely scheduling and monitoring arrival time of a service at a site by a requester of the service. System 100 will be explained in the context of municipal construction inspections, wherein a contractor 102 needing an inspection pertaining to a building project can call to a municipal office 104 a request for an inspection. Of course, contractor 102 is not the only party who may request an inspection. It will be understood that in many cases, contractor 102 also represents home owners, commercial property managers, and others. The request is entered into an automated system using wireless communications. In the example of FIG. 1, contractor 102 uses a smartphone 106 to communicate with system 100. Smartphone 106 may communicate via the internet or other wireless link(s). In this example, a plurality of mobile inspectors (shown representatively as vehicles 108 are in wireless communication with municipal office 104. The latter represents a central station having servers (not specifically shown) and other apparatus to maintain communications and records, and perform necessary administrative tasks for operating system 100.

The invention may be regarded as physical objects constituting system 100, and will be explained in terms of a method for remotely scheduling and monitoring arrival time of a service (e.g., a construction inspection, represented as mobile vehicles 108) by a requester (e.g., contractor 102) of the service. The method may comprise entering a request for the service to be performed at a requester specified site (e.g., a construction site) into system 100 for scheduling and monitoring arrival time of the service, and determining from a plurality of service providers (represented by mobile vehicles 108) an optimum selected service provider and tasking the selected service provider with providing the service requested by the requester. The method may further comprise assessing proximity of the selected service provider to determine a contemplated arrival time range for the selected service provider, annunciating an initial contemplated arrival time range to the requester, after passage of a time interval, reassessing proximity of the selected service provider to determine an updated contemplated arrival time range to the requester; and annunciating at least one subsequent contemplated arrival time range to the requester.

In this example, the requester may be a homeowner, contractor 102, or other private party engaged in a building project. The requester can utilize smartphone 106 to remotely request a required inspection at a site of a building project (not shown). System 100 then considers a pool of available potential inspectors (represented as having respective mobile vehicles 108). Selection may be based on factors such as that inspector who will become available the soonest, and proximity of candidate inspectors to the site.

Each inspector participating in system 100 may maintain a respective smartphone, portable computer, or other wireless communications device with data processing capability (none shown, but may be similar to smartphone 106). It is contemplated that system 100 will utilize downloaded applications not only in smartphone 106, but in the communications devices used by the inspectors.

The method may further comprise downloading into a requester wireless communications device (e.g., smartphone 106) a computer executable or implementable program or application which is functional to implement data processing steps for entering the request for the service. The entered request will later be reflected in the communications device of the inspectors.

The method may further comprise downloading into the requester wireless communications device a computer executable or implementable program or application which is functional to implement data processing steps for annunciating the initial contemplated arrival time range to the requester. This gives contractor 102 a relatively quick initial indication of arrival time, thereby allowing contractor 102 to plan that portion of the workday prior to the expected arrival of the designated inspector.

The method may further comprise downloading into the requester wireless communications device a computer executable or implementable program or application which is functional to implement data processing steps for annunciating the at least one subsequent contemplated arrival time range to the requester. A time range of contemplated arrival is more feasible to achieve accuracy than a specific time. This improves ability of contractor 102 to schedule that portion of his or her workday outside the contemplated inspection time more advantageously. Annunciating the contemplated arrival time or time range is wireless, and may be via a texted message, for example.

In the method, entering the request for the service into system 100 may comprise entering by the requester a requested time of day for the service. The method may further comprise downloading into the requester wireless communications device a computer executable or implementable program or application which is functional to implement data processing steps for entering by the requester a requested time of day for the service. This allows the requester to utilize time in the day for productive uses, and not merely wait for an inspector to show up.

Because relying on specific times may not be feasible, in the method, entering by the requester a requested time of day for the service may comprise entering by the requester a requested time range (i.e., a time window) for the service. This gives system 100 versatility which may for example enable successful scheduling of an inspector which scheduling might not be possible if system 100 were required to adhere to one specific time.

As time passes and unpredictable variables of typical workdays start to disappear from a scheduling scenario, in the method, each subsequent contemplated arrival time range may be shorter than each previously annunciated contemplated arrival time range. This enables contractor 102 to adjust his schedule advantageously.

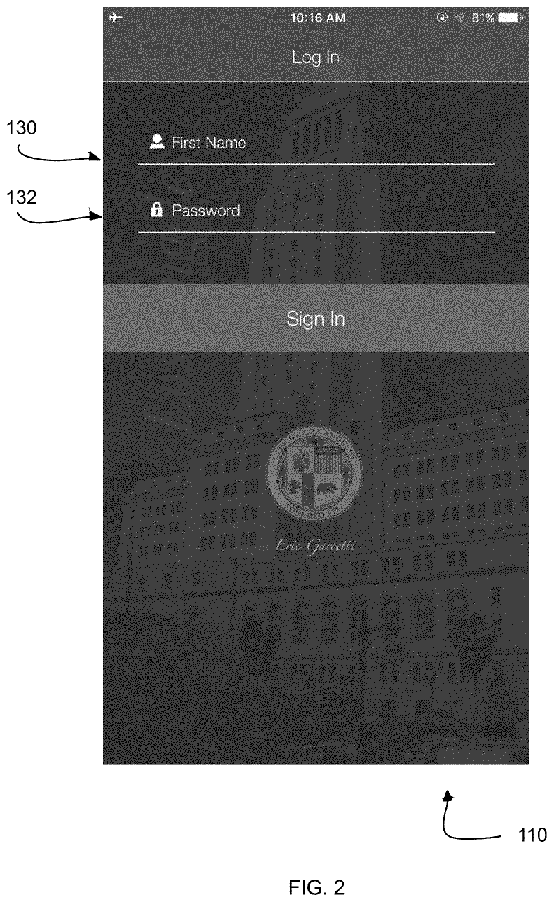

The method may further comprise downloading into the requester wireless communications device a computer executable or implementable program or application which is functional to implement data processing steps for entering by the requester a requested time range for the service. A downloaded program can implement communications and generate associated displays (as will be discussed with reference to FIGS. 2-10, to be described hereinafter).

In the method, entering the request for the service into the system for scheduling and monitoring arrival time of the service, annunciating the initial contemplated arrival time range to the requester, and annunciating the at least one subsequent contemplated arrival time range to the requester may be performed using at least one wireless communications link. This enables devices such as smartphone 106 to be utilized by contractor 102 to partially implement system 100, while not requiring a hard wired device which would obviously be objectionable on construction sites and if required for those who travel throughout their work day.

The method may further comprise determining when the selected service provider is en route to the requester specified site, and annunciating to the requester that the selected service provider is en route. This allows further refining of contractor's scheduling for the day of the inspection.

The method may further comprise downloading into the requester wireless communications device a computer executable or implementable program or application which is functional to implement data processing steps for annunciating to the requester that the selected service provider is en route. This enables automated annunciation of inspector progress at smartphone 106.

The method may further comprise providing a link to a source of graphic data showing location of the selected service provider while en route. This enables still more refining of the schedule of contractor 102.

In the method, annunciating the initial contemplated arrival time range to the requester further comprises annunciating queue size data to the requester; and annunciating the at least one subsequent contemplated arrival time range to the requester further comprise annunciating updated queue size data to the requester. Queue size refers to one or more inspection requests which have been assigned to the inspector prior to the request entered by contractor 102. This enables still more refined estimation of arrival time by contractor 102 of the selected inspector.

The method may further comprise downloading into the requester wireless communications device a computer executable or implementable program or application which is functional to implement data processing steps for annunciating queue size data to the requester, and annunciating updated queue size data to the requester. This enables system 100 to operate automatically.

In the method, determining from the plurality of service providers the optimum selected service provider and tasking the selected service provider with providing the service requested by the requester is performed based on a current work load for each candidate service provider and anticipated travel time of each candidate service provider to the requester specified site. A number of priorly assigned inspection and anticipated travel time are two of the largest variables in determining actual arrival time of the inspector, and will result in the most accurate estimate of arrival time or time range.

In the method, determining from the plurality of service providers the optimum selected service provider and tasking the selected service provider with providing the service requested by the requester is based on scope and magnitude of the requested service. This step assures that the requested inspection will have sufficient time in the workday to be completed on the requested day, and given the requested time interval.

The method may further comprise maintaining an accessible record of data transmitted to the requester in the system for scheduling and monitoring arrival time of the service, whereby an administrator of system 100 can monitor daily progress of each of the selected service providers in real time. This allows for efficient schedule of inspectors each day, and may further be used in employment records and monitoring of the overall inspection workload imposed on the municipality utilizing system 100.

The invention may be implemented as incorporating downloadable applications for both the private side, i.e., the requester(s) (e.g., contractor 102, homeowners needing inspections, etc.) and for the public side, i.e., service provider(s) (e.g., inspectors or other municipal personnel). The application for the inspectors will differ from that of contractor 102. FIG. 2 shows an exemplary opening screen 110 of an application suitable for use by both contractor 102 and also by inspectors. Opening screen 110 may enable authorized participation in system 100 by requiring a name 130 and a password 132. As used herein, screen may refer either to the physical screen, or alternatively, to content displayed on the physical screen, as determined by context herein.

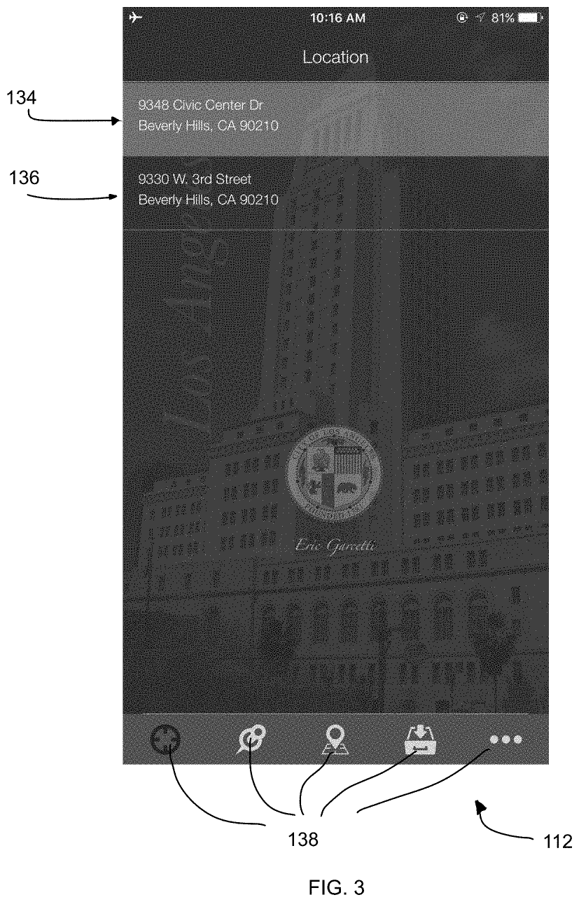

The next several screens are applicable to an application for smartphone 106 in possession of the requester (contractor 102). In screen 112 (FIG. 3) subsequent to opening screen 110, system 100 may cause the communications device to accommodate entry by contractor 102 for more than one inspection request (134, 136). Screen 112 is invoked by selecting one of the icons 138 at the bottom of the screen.

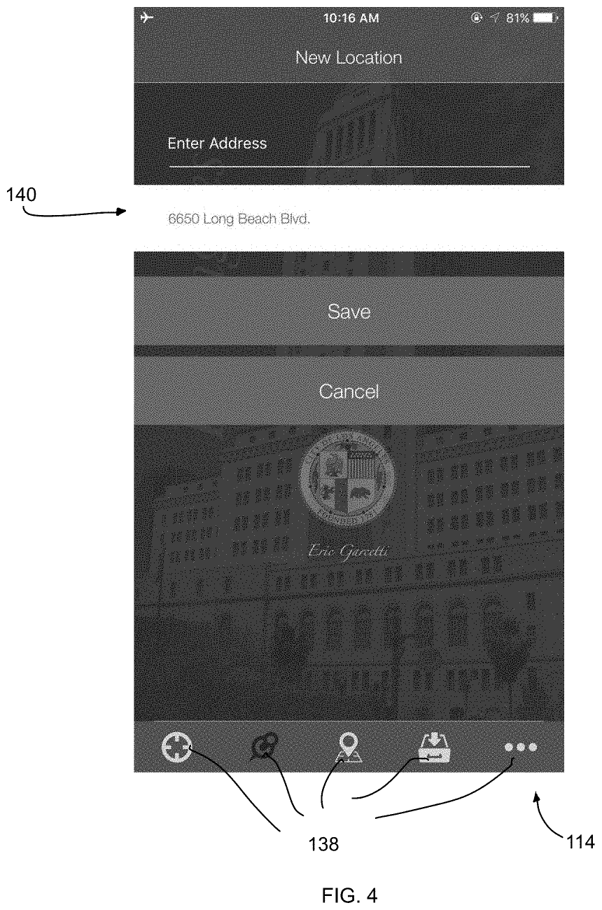

In a further screen 114 (FIG. 4), again invoked by selecting an icon 138 at the bottom, contractor 102 can enter an additional inspection request, identified by its address 140. Entered data can be edited, saved, or canceled.

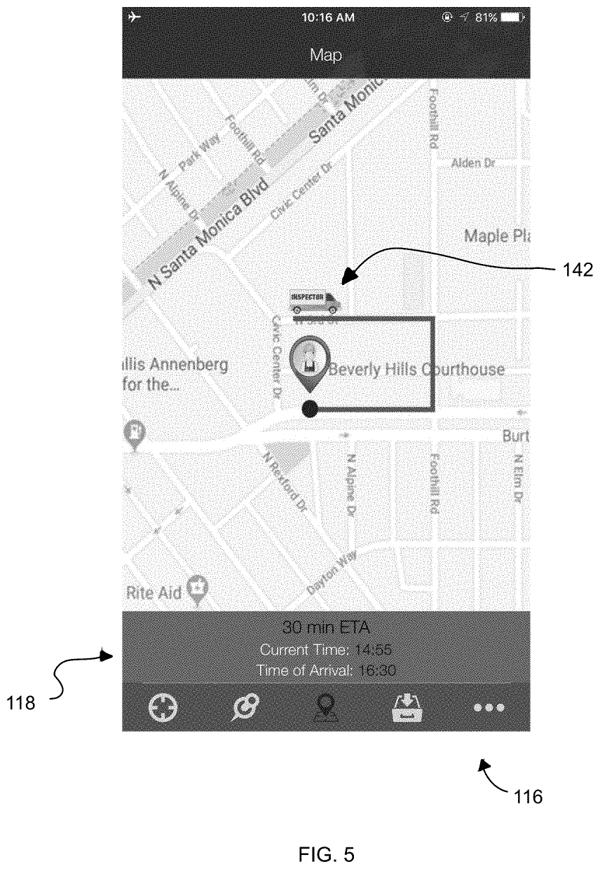

In a further screen 116 (FIG. 5), again invoked by selecting an icon 138, and coming into play when the inspector is now actually on his way to the requested site or having completed the last inspection but not yet literally en route, but when the requester is next in line for inspection, contractor 102 can monitor the inspector's location 142 via map in real time.

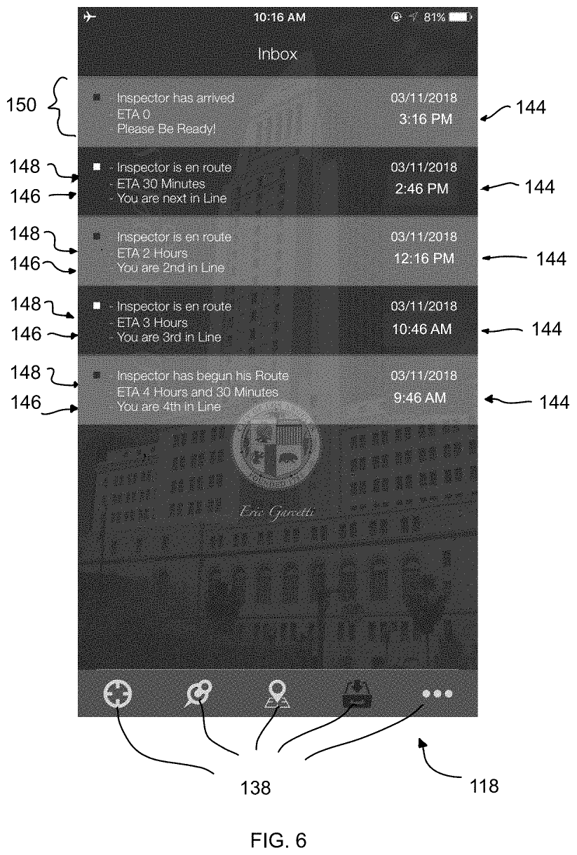

FIG. 6 shows a screen 118, again invoked by selection of an icon 138, in which the requester's status is indicated with an estimate of time of arrival 148 and requester's status 146 in the queue of outstanding inspection requests (both shown at the left of screen 118), and with a date and time stamp 144 (shown at the right of screen 118). Note that the latest status report 150, which is shown at the top of screen 118, announces inspector arrival, and advises the requester (contractor 102) to be ready.

In lieu of image screens for reproduction on smartphone 106, system 100 may send other communications, such as text messages (not illustrated). Text messages may include links enabling contractor 102 to summon map images (not illustrated) showing inspector progress in traveling to the contractor's requested inspection site.

The above sample screens 110-118 apply to an application for smartphone 106 in possession of contractor 102. The application may include a sign out screen (not shown).

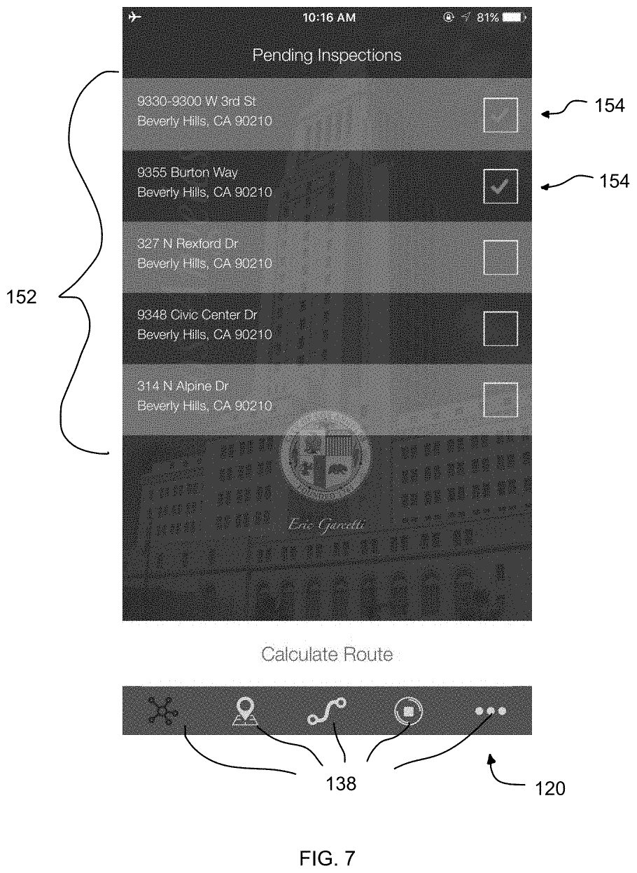

Turning to FIG. 7, there is shown an exemplary screen 120, intended for display on an inspector's communications device. It will be recalled from FIG. 2 that inspectors may utilize a sign in screen such as screen 110 shown in FIG. 2. In FIG. 7, again selected by an icon 138 at the bottom of the screen, there is shown a list 152 of inspections to be performed by an inspector. List 152 has been compiled by the administrator of system 100, and wirelessly transmitted to the inspector(s)' communications device(s). An inspector may enter data (e.g., as a checkmark 154, shown at the right in FIG. 7) indicating completion of each listed inspection.

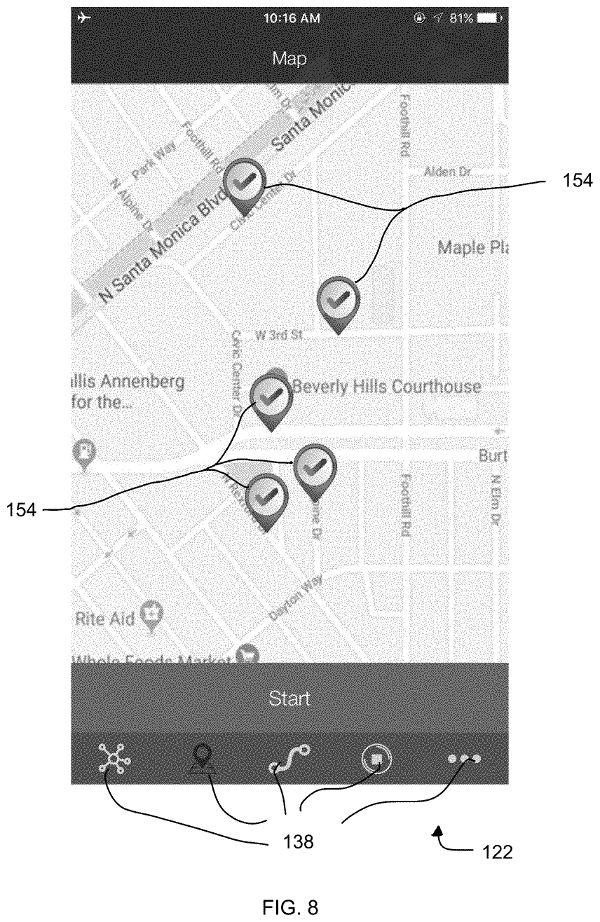

As shown in FIG. 8, there is shown a screen 122, again selected by one icon 138, showing the inspections listed in screen 120 as checkmark icons 154, but in map format.

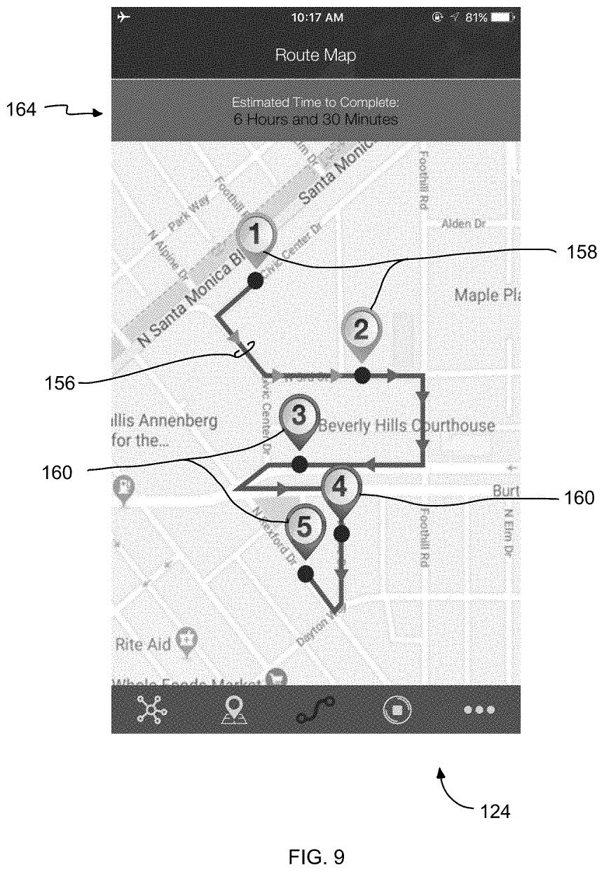

Referring to FIG. 9, a screen 124 may show a suggested route 156 (e.g. the fastest route) from inspection to inspection, and further, may differentiate between completed inspections 158 and pending inspections 160 by symbology, color rendering of location icons on the map, or in any other graphical way. Screen 124 may also display an estimated time 164 to complete the inspections. Screen 124 is also selected by an icon 138.

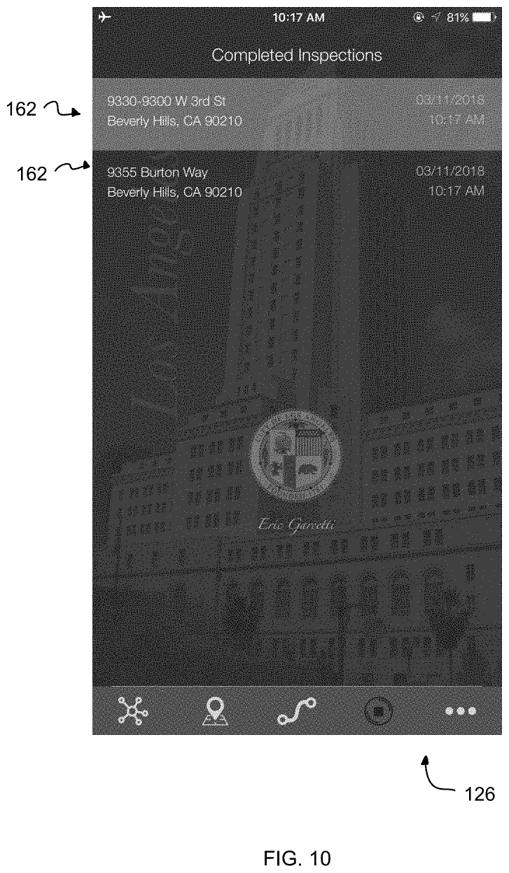

FIG. 10 shows a screen 126 listing completed inspections 162, as an alternative to graphic indication of completion as used in screen 124 of FIG. 9. Screen 126 may also be selected by icon.

In conclusion, system 100 may provide for screens 110-126 to appear on respective smartphone 106 and corresponding communications devices of the inspectors. And as described priorly, system 100 may provide for administration of screens 110-126 and also additional records and displays accessible to an authority maintaining and operating system 100 (e.g., the municipality utilizing system 100). This may be done in central station, represented in FIG. 1 as municipal office 104. System 100 may include additional display screens and other data handling devices (not shown), serviceable to implement the features set forth herein and in support of administrative functions such as payroll.

It will be appreciated that although description of the invention has been presented with reference to application to inspections of construction projects by municipal inspectors, those of skill in the art will recognize that there has been presented a system with additional applications. Notably, the novel system may be utilized by public or private mobile health and emergency care providers, public or private educational service providers, public or private delivery operations, public or private legal, accounting, engineering, repair, or computer servicing entities, security services, pet care services, and others.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method for remotely scheduling and monitoring arrival time of a service by a requester of the service, the method comprising:
entering a request for the service to be performed at a requester specified site into a system for scheduling and monitoring arrival time of the service;
determining from a plurality of service providers an optimum selected service provider and tasking the selected service provider with providing the service requested by the requester;
assessing proximity of the selected service provider to determine a contemplated arrival time range for the selected service provider;
annunciating an initial contemplated arrival time range to the requester;
after passage of a time interval, reassessing proximity of the selected service provider to determine an updated contemplated arrival time range to the requester; and
annunciating at least one subsequent contemplated arrival time range to the requester.

2. The method of claim 1, wherein entering the request for the service into the system comprises entering by the requester a requested time of day for the service.

3. The method of claim 2, further comprising downloading into a requester wireless communications device a computer executable or implementable program or application which is functional to implement data processing steps for entering by the requester a requested time of day for the service.

4. The method of claim 2, wherein entering by the requester a requested time of day for the service comprises entering by the requester a requested time range for the service.

5. The method of claim 4, wherein each subsequent contemplated arrival time range is shorter than each previously annunciated contemplated arrival time range.

6. The method of claim 4, further comprising downloading into a requester wireless communications device a computer executable or implementable program or application which is functional to implement data processing steps for entering by the requester a requested time range for the service.

7. The method of claim 1, wherein entering the request for the service into the system for scheduling and monitoring arrival time of the service, annunciating the initial contemplated arrival time range to the requester, and annunciating the at least one subsequent contemplated arrival time range to the requester are performed using at least one wireless communications link.

8. The method of claim 1, further comprising
determining when the selected service provider is en route to the requester specified site; and
annunciating to the requester that the selected service provider is en route.

9. The method of claim 8, further comprising downloading into a requester wireless communications device a computer executable or implementable program or application which is functional to implement data processing steps for annunciating to the requester that the selected service provider is en route.

10. The method of claim 9, further comprising providing a link to a source of graphic data showing location of the selected service provider while en route.

11. The method of claim 1, wherein annunciating the initial contemplated arrival time range to the requester further comprises annunciating queue size data to the requester; and annunciating the at least one subsequent contemplated arrival time range to the requester further comprise annunciating updated queue size data to the requester.

12. The method of claim 11, further comprising downloading into a requester wireless communications device a computer executable or implementable program or application which is functional to implement data processing steps for annunciating queue size data to the requester, and annunciating updated queue size data to the requester.

13. The method of claim 1, wherein determining from the plurality of service providers the optimum selected service provider and tasking the selected service provider with providing the service requested by the requester is performed based on a current work load for each candidate service provider and anticipated travel time of each candidate service provider to the requester specified site.

14. The method of claim 1, wherein determining from the plurality of service providers the optimum selected service provider and tasking the selected service provider with providing the service requested by the requester is based on scope and magnitude of the requested service.

15. The method of claim 1, further comprising downloading into a requester wireless communications device a computer executable or implementable program or application which is functional to implement data processing steps for entering the request for the service.

16. The method of claim 1, further comprising downloading into a requester wireless communications device a computer executable or implementable program or application which is functional to implement data processing steps for annunciating the initial contemplated arrival time range to the requester.

17. The method of claim 1, further comprising downloading into a requester wireless communications device a computer executable or implementable program or application which is functional to implement data processing steps for annunciating the at least one subsequent contemplated arrival time range to the requester.

18. The method of claim 1, further comprising maintaining an accessible record of data transmitted to the requester in the system for scheduling and monitoring arrival time of the service, whereby the service provider can monitor daily progress of each of the selected service providers in real time.
